(19) United States
(12) Patent Application Publication
(10) Pub. No.: US 2014/0007379 A1
(43) Pub. Date: Jan. 9, 2014

(54) Hinge and an Electronic Device Incorporating the Same

(71) Applicant: Wistron Corporation, New Taipei City (TW)

(72) Inventor: Chun Fei Yang, New Taipei City (TW)

(21) Appl. No.: 13/869,234

(22) Filed: Apr. 24, 2013

(30) Foreign Application Priority Data
Jul. 4, 2012 (TW) 101124010

(51) Int. Cl. G06F 1/16

(52) U.S. Cl. CPC G06F 1/1681
USPC 16/277

(57) ABSTRACT

A hinge includes a first coupling member including an axle with a non-circular cross section, and a second coupling member including a sleeve and an elastic abutting arm. The axle includes a protruding portion formed on a curvy outer peripheral surface thereof. The sleeve is rotatably sleeved on the pivot axle. The arm is spaced from the sleeve, and abuts against the outer peripheral surface. The protruding portion is in a rotation path of the arm such that when the second coupling member is rotated to a predetermined angle relative to the first coupling member along a direction, the arm is elastically deformed to abut against the protruding portion and form a torque in the direction.

### CROSS-REFERENCE TO RELATED APPLICATION

This application claims priority of Taiwanese Patent Application No. 101124010, filed on Jul. 4, 2012, the disclosure of which is incorporated herein by reference.

### BACKGROUND OF THE INVENTION

1. Field of the Invention

The invention relates to a hinge, and more particularly to a hinge that is disposed between a main body and a cover body and has an autolock function and an electronic device incorporating the hinge.

2. Description of the Related Art

A conventional foldable electronic device includes a main body and a cover body pivoted to the main body by the hinge. In order to realize the autolock of the cover body on the main body, most existing hinges provide, to be sleeved on an axle, two cam components cooperating with each other and an elastic device having a plurality of leaf springs.

Since trend of electronic device designs is to be thin, light, and compact, the volume of the hinge needs to be reduced and the length of the axle may be shortened to an extent where there is insufficient length in the axle to allow the cam components and the elastic device to be simultaneously sleeved thereon. Therefore, how to solve the above problem is a subject matter to be studied.

### SUMMARY OF THE INVENTION

Therefore, an object of the present invention is to provide a hinge that includes fewer components, and that has a small volume and an effectively improved service life.

Another object of the present invention is to provide an electronic device incorporating a hinge, where the hinge includes fewer components and has a small volume and an effectively improved service life.

Still another object of the present invention is to provide an electronic device incorporating a hinge, where with the provision of the hinge, when a cover body of the electronic device brings the hinge to rotate to a predetermined angle along a rotating direction, the cover body automatically pivots to a closed state where the cover body is closed on a main body of the electronic device.

According to one aspect of the present invention, there is provided a hinge that includes a first coupling member and a second coupling member. The first coupling member includes a pivot axle. The pivot axle includes at least one axle segment that has a non-circular cross section perpendicular to a central axis of the pivot axle. The axle segment includes a curvy outer peripheral surface and a protruding portion that is formed on the outer peripheral surface. The second coupling member includes a connecting plate, at least one sleeve and at least one elastic abutting arm. The connecting plate has a side end. The sleeve is bent and extends from the side end, and includes a free end that is spaced from the connecting plate so as to form a gap therewith. The sleeve is rotatably sleeved on the pivot axle and is capable of being positioned on the pivot axle. The elastic abutting arm extends from the side end and is spaced from the sleeve. The elastic abutting arm corresponds in position to the axle segment and abuts against the outer peripheral surface. The protruding portion is disposed in a path of rotation of the elastic abutting arm, such that when the second coupling member is rotated to a predetermined angle relative to the first coupling member along a closing direction, the elastic abutting arm is elastically deformed to abut against the protruding portion and form a torque in the closing direction.

According to another aspect of the present invention, there is provided an electronic device that includes a main body, a cover body and a hinge. The hinge is connected between the main body and the cover body. The cover body is pivotable relative to the main body between an open state where the cover body uncovers the main body and a closed state where the cover body covers the main body. The hinge includes a first coupling member and a second coupling member. The first coupling member includes a securing plate that is connected to the main body and a pivot axle that protrudes from the securing plate. The pivot axle includes at least one axle segment that has a non-circular cross section perpendicular to a central axis of the pivot axle. The axle segment includes a curvy outer peripheral surface and a protruding portion that is formed on the outer peripheral surface. The second coupling member includes a connecting plate that is connected to the cover body, at least one sleeve and at least one elastic abutting arm. The connecting plate has a side end. The sleeve is bent and extends from the side end, and includes a free end that is spaced from the connecting plate to form a gap therewith. The sleeve is rotatably sleeved on the pivot axle and is capable of being positioned on the pivot axle. The elastic abutting arm extends from the side end and is spaced from the sleeve. The elastic abutting arm corresponds in position to the axle segment and abuts against the outer peripheral surface. The protruding portion is disposed in a path of rotation of the elastic abutting arm, such that when the cover body brings the second coupling member to rotate to a predetermined angle at the open state relative to the first coupling member along a closing direction, the elastic abutting arm is elastically deformed to abut against the protruding portion and form a torque in the closing direction, so as to enable the cover body to automatically move into the closed state. The position of the protruding portion corresponds to the predetermined angle.

Based on the above technical means, the electronic device of the present invention has the following advantages and effects. Since the hinge is designed such that the sleeve of the second coupling member is rotatably sleeved on the pivot axle of the first coupling member and is capable of being positioned on the pivot axle, and the elastic abutting arm abuts against the axle segment of the pivot axle and provides the torque to realize autolock of the cover body, the hinge has fewer components and a small volume in design, thereby reducing the space occupied thereby in the main body and the cover body. Furthermore, during the opening and closing of the cover body on the main body through the hinge, the autolock function of the cover body can be achieved by the cooperation of the elastic abutting arm and the axle segment. Due to a good elasticity of the elastic abutting arm, the elastic fatigue problem is unlikely even after a long-term use, thereby effectively improving the service life of the hinge.

### BRIEF DESCRIPTION OF THE DRAWINGS

Other features and advantages of the present invention will become apparent in the following detailed description of the embodiments with reference to the accompanying drawings, of which:

FIG. 1 is a side view of a first embodiment of an electronic device according to the present invention, illustrating a cover body at an open state relative to a main body;

FIG. 2 is a fragmentary enlarged view of the first embodiment, illustrating a hinge connected between the main body and the cover body;

FIG. 3 is a perspective view of the hinge of the first embodiment, illustrating a second coupling member sleeved on a pivot axle of a first coupling member;

FIG. 4 is an exploded perspective view of the hinge in FIG. 3, illustrating detailed structures of the first coupling member and the second coupling member;

FIG. 5 is a sectional view taken along Line 5-5 in FIG. 3, illustrating an elastic abutting arm abutting against an outer peripheral surface of a first axle segment of the pivot axle;

FIG. 6 is a sectional view taken along Line 6-6 in FIG. 3, illustrating a sleeve sleeved on a second axle segment of the pivot axle;

FIG. 7 is another side view of the electronic device of the first embodiment, illustrating the cover body pivoted to a predetermined angle relative to the main body through the hinge in a closing direction I;

FIG. 8 is a sectional view of the hinge according to the first embodiment, illustrating the elastic abutting arm abutting against a protruding portion of the first axle segment when the cover body is pivoted to the predetermined angle as shown in FIG. 7;

FIG. 9 is another side view of the first embodiment, illustrating the cover body driven by the torque of the hinge to automatically pivot to a closed state where the cover body is locked on the main body;

FIG. 10 is another sectional view of the hinge according to the first embodiment, illustrating a positional relationship between the elastic abutting arm and the first axle segment when the cover body is at the closed state;

FIG. 11 is a sectional view of the hinge according to an alternative form of the first embodiment when the cover body is at the open state;

FIG. 12 is another sectional view of the hinge according to the alternative form, illustrating the cover body at the locked state;

FIG. 13 is an exploded perspective view of the hinge of a second embodiment of the electronic device according to the present invention, illustrating detailed structures of the first coupling member and the second coupling member;

FIG. 14 is a sectional view of the hinge according to the second embodiment, illustrating a hook of the elastic abutting arm being engaged in one of a plurality of positioning grooves when the cover body is at the open state;

FIG. 15 is a perspective view of the hinge of a third embodiment of the electronic device according to the present invention, illustrating the second coupling member sleeved on the pivot axle of the first coupling member;

FIG. 16 is an exploded perspective view of the hinge according to the third embodiment, illustrating detailed structure of the first coupling member and the second coupling member;

FIG. 17 is an exploded perspective view of the hinge a fourth embodiment of the electronic device according to the present invention, illustrating detailed structures of the first coupling member and the second coupling member;

FIG. 18 is a sectional view of the hinge according to the fourth embodiment, illustrating the hook of the elastic abutting arm engaged in one of the positioning grooves when the cover body is at the open state;

FIG. 19 is a perspective view of the hinge of a fifth embodiment of the electronic device according to the present invention, illustrating the second coupling member sleeved on the pivot axle of the first coupling member;

FIG. 20 is an exploded perspective view of the hinge according to the fifth embodiment, illustrating detailed structures of the first coupling member and the second coupling member;

FIG. 21 is an exploded perspective view of the hinge of a sixth embodiment of the electronic device according to the present invention, illustrating detailed structures of the first coupling member and the second coupling member;

FIG. 22 is a sectional view of the hinge according to the sixth embodiment, illustrating the hook of the elastic abutting arm engaged in one of the positioning grooves when the cover body is at the open state;

FIG. 23 is a perspective view of the hinge of a seventh embodiment of the electronic device according to the present invention, illustrating the second coupling member sleeved on the pivot axle of the first coupling member;

FIG. 24 is an exploded perspective view of the hinge according to the seventh embodiment, illustrating detailed structures of the first coupling member and the second coupling member;

FIG. 25 is an exploded perspective view of the hinge of an eighth embodiment of the electronic device according to the present invention, illustrating detailed structures of the first coupling member and the second coupling member; and

FIG. 26 is a sectional view of the hinge according to the eighth embodiment, illustrating the hook of the elastic abutting arm engaged in one of the positioning grooves when the cover body is at the open state.

### DETAILED DESCRIPTION OF THE EMBODIMENTS

The above-mentioned and other technical contents, features, and effects of this invention will be clearly presented from the following detailed description of the eight embodiments in coordination with the reference drawings. The technical means for achieving the objects of the present invention and the effects thereof may be further comprehended through the description of the embodiments. However, the accompanying drawings are illustrated for reference only and should not be regarded as limitations to the scope of the present invention.

Before this invention is described in detail, it should be noted that, in the following description, like elements are designated by the same reference numerals.

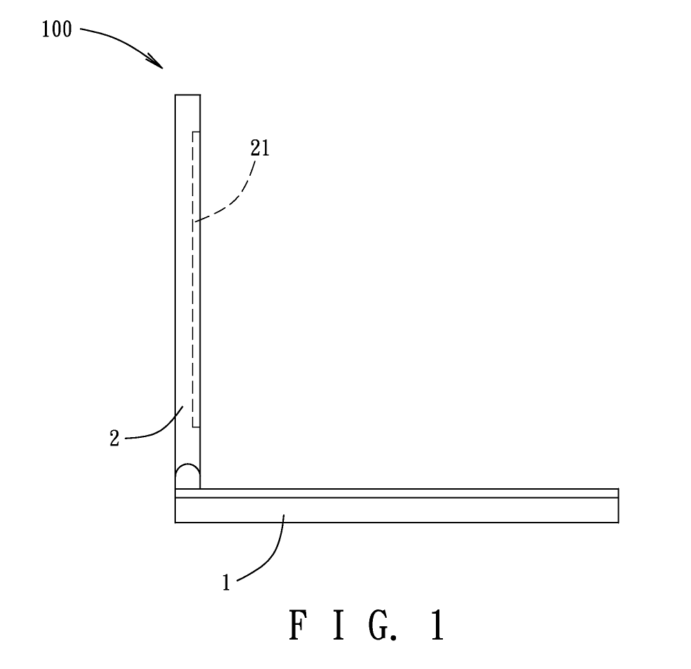

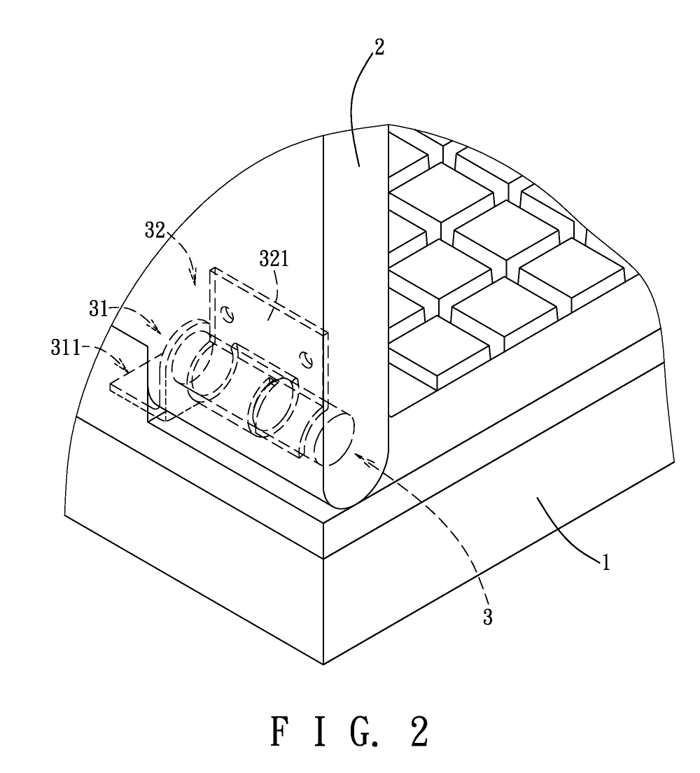

FIGS. 1 and 2 illustrate a first embodiment of an electronic device 100 according to the pre sent invention. The electronic device 100 includes a main body 1, a cover body 2 and two hinges 3 (only one is shown in FIG. 2) connected between the main body 1 and the cover body 2. The cover body 2 is pivotable relative to the main body 1 through the two hinges 3. In this embodiment, the electronic device 100 is exemplified as a notebook computer. The main body 1 includes an electronic component (not shown), and the electronic component includes a mother board, a hard disk and other electronic elements required for the normal operation of the notebook computer. The cover body 2 includes a display module 21 electrically connected to the electronic component. It should be noted that the electronic device 100 may also be a foldable electronic device such as a mobile phone or a PDA (Personal Digital Assistant), which includes a main body and a cover body that are pivotable relative to each other. Furthermore, for different types of electronic devices 100, one or more than two hinges 3 may be used.

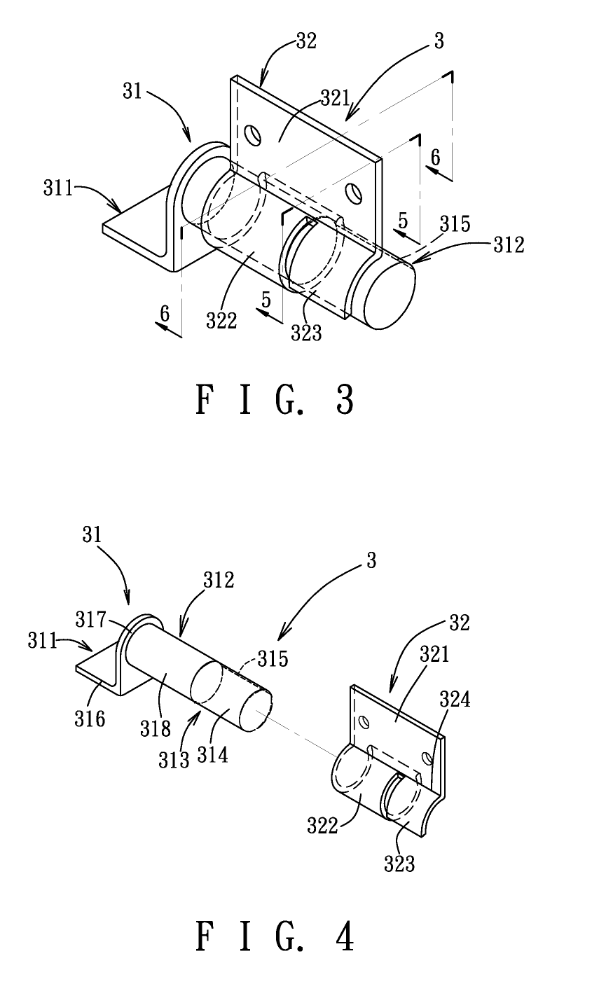

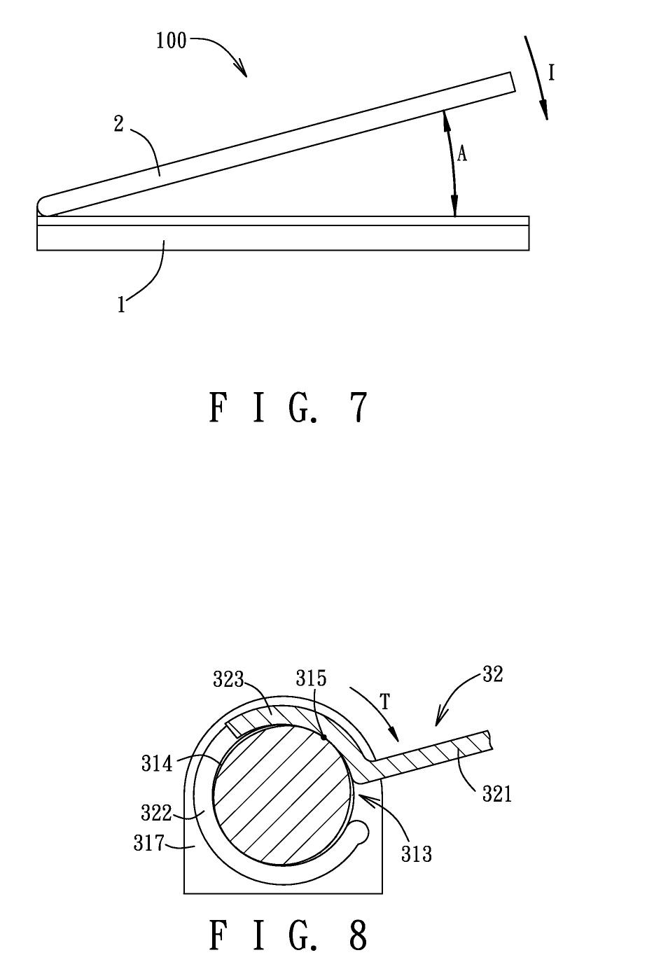

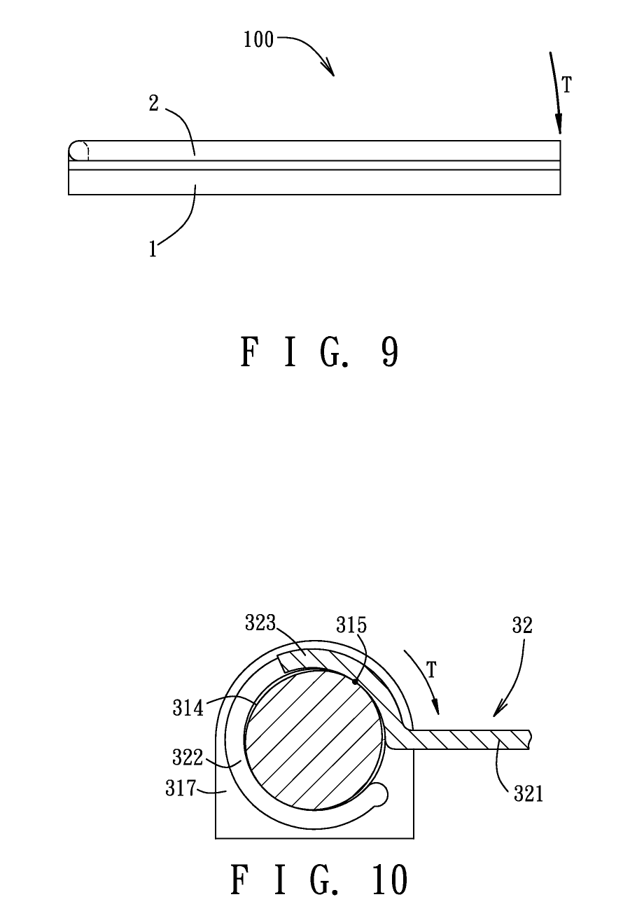

As shown in FIGS. 3, 4, 5 and 6, each of the hinges 3 includes a first coupling member 31 and a second coupling member 32. In this embodiment, the first coupling member 31 and the second coupling member 32 are each made of a metal material. The first coupling member 31 includes a securing plate 311 secured to the main body 1 (as shown in FIG. 2) and a pivot axle 312 protruding from the securing plate 311. The pivot axle 312 includes at least one first axle segment 313. The first axle segment 313 has a non-circular cross section perpendicular to a central axis of the pivot axle 312. The first axle segment 313 includes a curvy outer peripheral surface 314 and a protruding portion 315 formed on the outer peripheral surface 314. The second coupling member 32 includes a connecting plate 321 secured to the cover body 2 (as shown in FIG. 2), at least one sleeve 322 and at least one elastic abutting arm 323. The connecting plate 321 has a side end 324. The sleeve 322 is bent and extends from the side end 324 of the connecting plate 321, and includes a free end 325 spaced from the connecting plate 321. A gap 326 is formed between the free end 325 and the connecting plate 321. The sleeve 322 is rotatably sleeved on the pivot axle 312, and is capable of being positioned on the pivot axle 312. The elastic abutting arm 323 extends from the side end 324 of the connecting plate 321 and is spaced from the sleeve 322. The elastic abutting arm 323 corresponds in position to the first axle segment 313 and abuts against the outer peripheral surface 314. The protruding portion 315 of the first axle segment 313 is disposed in a path of rotation of the elastic abutting arm 323, such that when the cover body 2 brings the second coupling member 32 to rotate relative to the first coupling member 31 along a rotating direction (I) to a predetermined angle as shown in FIG. 7, the elastic abutting arm 323 is elastically deformed to abut against the protruding portion 315 and form a torque (T) (as shown in FIG. 8) in the rotating direction (I), so as to enable the cover body 2 to automatically pivot to a closed state (as shown in FIG. 9) where the cover body 2 is closed on the main body 1.

With the design that the sleeve 322 of the second coupling member 32 is rotatably sleeved on the pivot axle 312 of the first coupling member 31 and is capable of being positioned on the pivot axle 312, and the elastic abutting arm 323 abuts against the first axle segment 313 of the pivot axle 312 and provides the torque (T) to realize the autolock of the cover body 2, the hinges 3 of this invention have fewer components and the space occupied thereby in the main body 1 and the cover body 2 can be reduced. Furthermore, during the opening and closing of the cover body 2 relative to the main body 1 through the hinges 3, the autolock function of the cover body 2 can be achieved by the cooperation of the elastic abutting arm 323 and the first axle segment 313. Due to a good elasticity, elastic fatigue will not easily occur for the elastic abutting arm 323 even after a long term use, thereby effectively improving the service life of the hinges 3.

Hereinafter, specific configurations and operations of the electronic device 100 and the hinges 3 thereof will be detailed.

As shown in FIGS. 4, 5 and 6, the securing plate 311 of the first coupling member 31 is L-shaped and includes a first plate body 316 and a second plate body 317 protruding from one side of the first plate body 316. The first plate body 316 may be fastened to the main body 1 (as shown in FIG. 2), for example, by a screw fastening method. In this embodiment, the number of the first axle segment 313 is one, and the first axle segment 313 is embodied as a cam. The protruding portion 315 of the first axle segment 313 extends along an axial direction of the first axle segment 313. The pivot axle 312 further includes a second axle segment 318 protruding from one side of the second plate body 317 of the securing plate 311 that is opposite to the first plate body 316. The second axle segment 318 is connected to one end of the first axle segment 313, and has a circular cross section perpendicular to the central axis of the pivot axle 312.

The connecting plate 321 of the second coupling member 32 may be fastened to the cover body 2 (as shown in FIG. 2), for example, by the screw fastening method. In this embodiment, the number of the sleeve 322 of the second coupling member 32 and the number of the elastic abutting arm 323 of the second coupling member 32 are both one, and the sleeve 322 has a C-shaped cross section perpendicular to the central axis of the pivot axle 312. The sleeve 322 is rotatably sleeved on the second axle segment 318. The sleeve 322 is in tight contact with the second axle segment 318, such that when the second coupling member 32 rotates relative to the pivot axle 312 of the first coupling member 31, by means of a frictional force between the sleeve 322 and the second axle segment 318, the cover body 2 is capable of being positioned relative to the pivot axle 312 through the sleeve 322 of the second coupling member 32. Due to the circular cross section of the second axle segment 318 and the C-shaped cross section of the sleeve 322, during the rotation of the second coupling member 32 relative to the pivot axle 312 of the first coupling member 31, the sleeve 322 remains in tight contact with the second axle segment 318 without deformation, thereby allowing the sleeve 322 to be stably sleeved on the pivot axle 312.

As shown in FIGS. 4, 5, 6 and 7, in order to adjust an angle included by the cover body 2 and the main body 1 when the cover body 2 is in an open state as shown in FIG. 1, a force is applied along the closing direction (I) or along an opening direction opposite to the closing direction (I) to pivot the cover body 2, so as to bring the second coupling member 32 to rotate relative to the pivot axle 312 of the first coupling member 31. When the cover body 2 is pivoted to a desired angle, the cover body 2 may be stably positioned at the desired angle, by means of the frictional forces between the sleeve 322 of the second coupling member 32 and the second axle segment 318 of the first coupling member 31 and between the elastic abutting arm 323 and the outer peripheral surface 314 of the first axle segment 313.

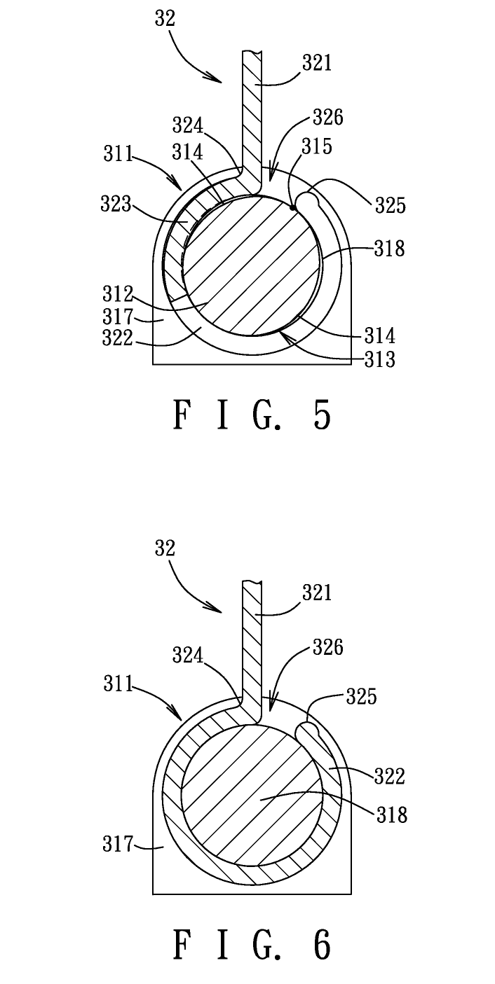

As shown in FIGS. 5, 7 and 8, in order to transition the cover body 2 from the open state as shown in FIG. 1 to the closed state as shown in FIG. 9, where the cover body 2 of the electronic device 100 covers the main body 1, a force needs to be applied along the closing direction (I) to pivot the cover body 2 relative to the main body 1. In FIG. 5, since the distance between a segment of the outer peripheral surface 314 defined between the protruding portion 315 and the connecting plate 321 and a rotating center of the first axle segment 313 is greater than the distance between the elastic abutting arm 323 and the rotating center of the first axle segment 313, during the rotation of the second coupling member 32 relative to the pivot axle 312 of the first coupling member 31 as brought by pivotal movement of the cover body 2 relative to the main body 1 in the closing direction (I), the elastic abutting arm 323 is pushed by the outer peripheral surface 314 of the first axle segment 313 to bend and deform outwardly and accumulate an elastic restoring force. Since the distance between the protruding portion 315 and the rotating center of the first axle segment 313 is greater than the distance of the abovementioned segment of the outer peripheral surface 314 and the rotating center of the first axle segment 313, as the elastic abutting arm 323 is rotated to approach the protruding portion 315, the elastic abutting arm 323 is pushed by the outer peripheral surface 314 to bend and deform outwardly to a greater extent. When the elastic abutting arm 323 is rotated to abut against the protruding portion 315, the elastic abutting arm 323 is pushed by the protruding portion 315 and at this time, the elastic abutting arm 323 is bent and deformed outwardly to the greatest extent.

As shown in FIGS. 7, 8, 9 and 10, when the cover body 2 brings the second coupling member 32 to rotate to a predetermined angle (A) as shown in FIG. 7 relative to the pivot axle 312 of the first coupling member 31, that is, when the angle included by the cover body 2 and the main body 1 is the predetermined angle (A) of, for example, 15 degrees, since the position of the protruding portion 315 corresponds to the predetermined angle (A), the elastic abutting arm 323 is elastically deformed to abut against the protruding portion 315 of the first axle segment 313 and slightly pass over the protruding portion 315. The part of the elastic abutting arm 323 that passes over the protruding portion 315 has a tendency to approach the outer peripheral surface 314 due to the elastic restoring force accumulated therein. That is to say, the elastic restoring force accumulated by the elastic abutting arm 323 allows the elastic abutting arm 323 to generate a torque (T) in the closing direction (I), so as to enable the second coupling member 32 to automatically rotate in the closing direction (I) relative to the pivot axle 312 (as shown in FIG. 4). Thus, the user need not further apply a force to pivot the cover body 2 after reaching the predetermined angle (A) shown in FIG. 7, and the cover body 2 may automatically pivot to the closed state where the cover body 2 is disposed over the main body 1 (as shown in FIG. 9).

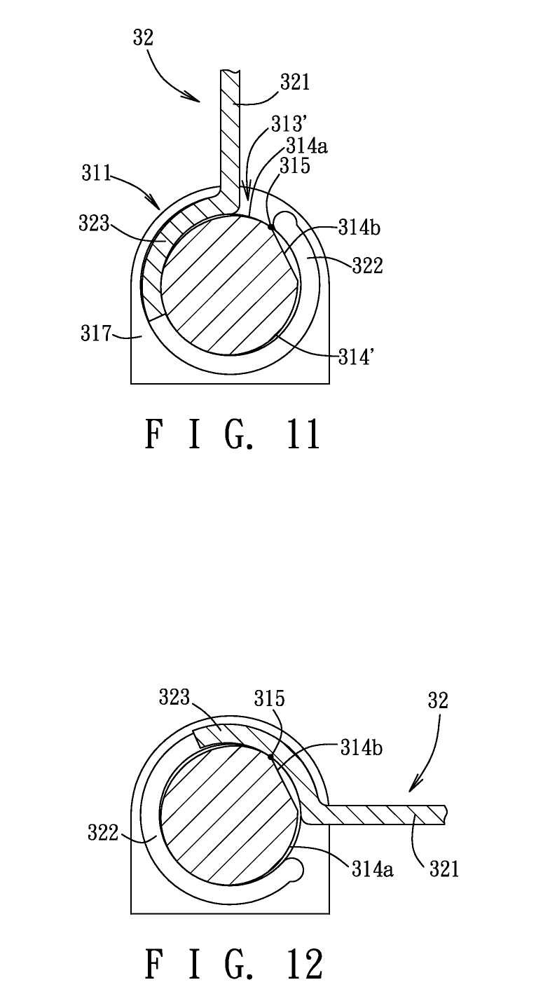

As shown in FIGS. 11 and 12, it should be particularly noted that the first axle segment 313 is not limited to the cam as described above, and the outer peripheral surface 314′ of the first axle segment 313′ may also include a curved section 314a and a straight section 314b connected with the curved section 314a. The protruding portion 315 is formed at a junction of the curved section 314a and the straight section 314b. In this embodiment, when the cover body 2 brings the second coupling member 32 to rotate to the predetermined angle (A) as shown in FIG. 7 relative to the pivot axle 312 of the first coupling member 31, the elastic abutting arm 323 is pushed by the protruding portion 315 of the first axle segment 313′ to bend and deform outwardly and accumulate the elastic restoring force.

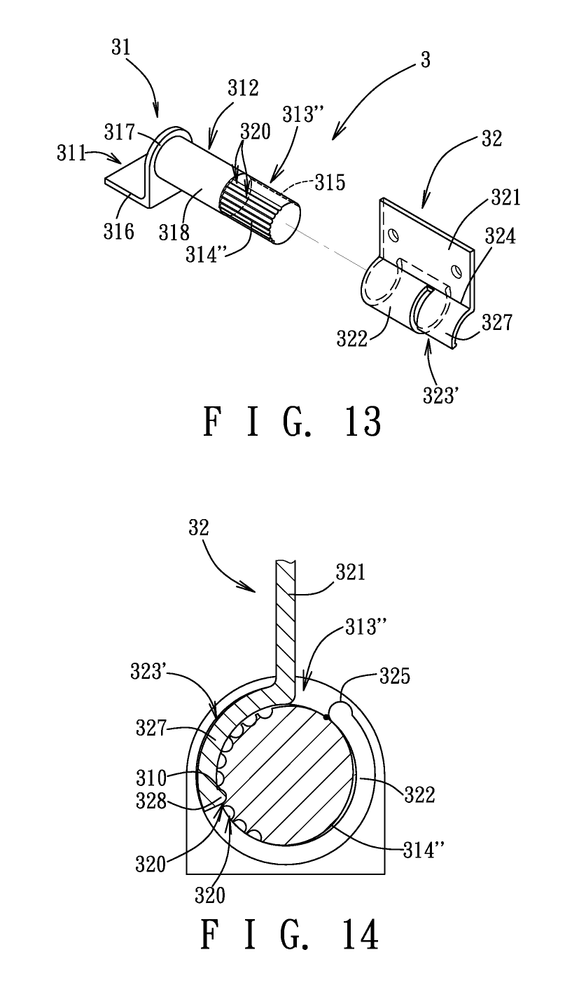

FIGS. 13 and 14 illustrate a second embodiment of the electronic device 100 (as shown in FIG. 1) according to the present invention. The overall structure and operation of the second embodiment are substantially the same as those of the first embodiment, except that the structures of the first axle segment 313″ and the elastic abutting arm 323′ are slightly different.

In this embodiment, the outer peripheral surface 314″ of the first axle segment 313″ is formed with a plurality of positioning grooves 320 that are spaced from one another and that respectively correspond to different angles. Each of the positioning grooves 320 is, for example, arc-shaped in cross section. The elastic abutting arm 323′ includes an elastic arm portion 327 connected with the connecting plate 321 and a hook 328 protruding from an end of the elastic arm portion 327. The hook 328 has a shape in cross section matching that of each positioning groove 320 and thus also is arc-shaped. The hook 328 of the elastic abutting arm 323′ is removably engaged in one of the positioning grooves 320.

When the user applies a force to pivot the cover body 2 (as shown in FIG. 1), the hook 328 is blocked by a groove wall 310 of the first axle segment 313″ and is pushed outwardly to bring the elastic arm portion 327 to bend and deform outwardly, so as to enable the hook 328 to be disengaged from one of the positioning grooves 320 in which it is originally engaged and abut against a part of the outer peripheral surface 314 with no positioning grooves 320, wherein the groove wall 310 defines a corresponding one of the positioning grooves 320. With the design that each positioning groove 320 has an arc-shaped cross section and the hook 328 has an arc-shaped cross section that matches thereto, the cover body 2, when pivoting relative to the main body 1, may smoothly bring the hook 328 to be disengaged from the positioning groove 320 in which the hook 328 is originally engaged, and when the hook 328 is rotated to be aligned with another one of the positioning grooves 320, due to the elastic restoring force accumulated within the elastic arm portion 327, the hook 328 is automatically engaged in said another positioning groove 320, and the user can feel the stop generated when the hook 328 is engaged in the positioning groove 320 and accordingly determine if the hook 328 is engaged in said another positioning groove 320 indeed. If the user continuously pivots the cover body 2 relative to the main body 1, the user may feel a series of stops.

When the cover body 2 is pivoted by the user to a desired angle relative to the main body 1, in addition to the frictional forces between the sleeve 322 of the second coupling member 32 and the second axle segment 318 and between the elastic abutting arm 323′ and the outer peripheral surface 314 of the first axle segment 313″, the hook 328 of the elastic abutting arm 323′ is engaged in the corresponding positioning groove 320, and thus the cover body 2 may be stably positioned at the desired angle.

It should be noted that each positioning groove 320 may also be tooth-shaped or zigzag-shaped in cross section, and the shape of the cross section of the hook 328 may be accordingly adjusted to match the shape of the cross section of each positioning groove 320.

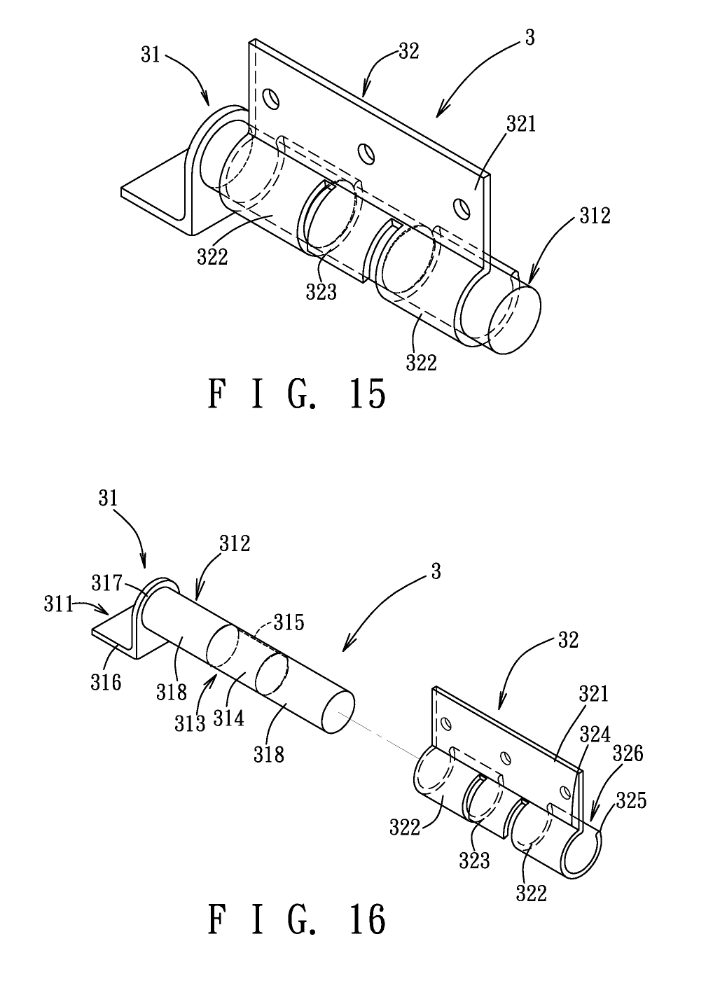

FIGS. 15 and 16 illustrate a third embodiment of the electronic device 100 (as shown in FIG. 1) according to the present invention. The overall structure and operation of the third embodiment are substantially the same as those of the first embodiment, except that structures of the first coupling member 31 and the second coupling member 32 are slightly different.

In this embodiment, the pivot axle 312 of the first coupling member 31 includes two second axle segments 318 respectively connected to two opposite ends of the first axle segment 313. The second coupling member 32 includes two sleeves 322 that are bent and that extend from the side end 324 of the connecting plate 321 and that are separately located proximate to two opposite ends of the elastic abutting arm 323. Each of the sleeves 322 is rotatably sleeved on a corresponding one of the second axle segments 318. With the design that two sleeves 322 are separately located at the opposite ends of the elastic abutting arm 323 and respectively sleeved on the two second axle segments 318, the second coupling member 32 may smoothly and stably rotate relative to the pivot axle 312 of the first coupling member 31, thereby avoiding the generation of wobbling during the rotation of the second coupling member 32.

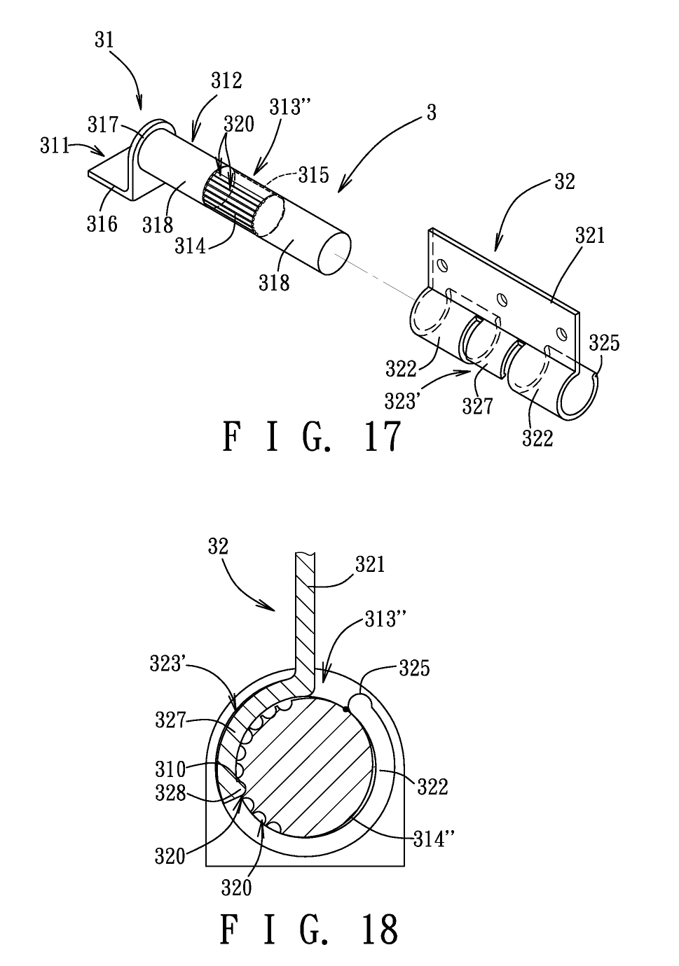

FIGS. 17 and 18 illustrate a fourth embodiment of the electronic device 100 (as shown in FIG. 1) according to the present invention. The overall structure and operation of the fourth embodiment are substantially the same as those of the third embodiment, while the design of the first axle segment 313″ of the first coupling member 31 and the design of the elastic abutting arm 323′ of the second coupling member 32 are the same as those of the second embodiment.

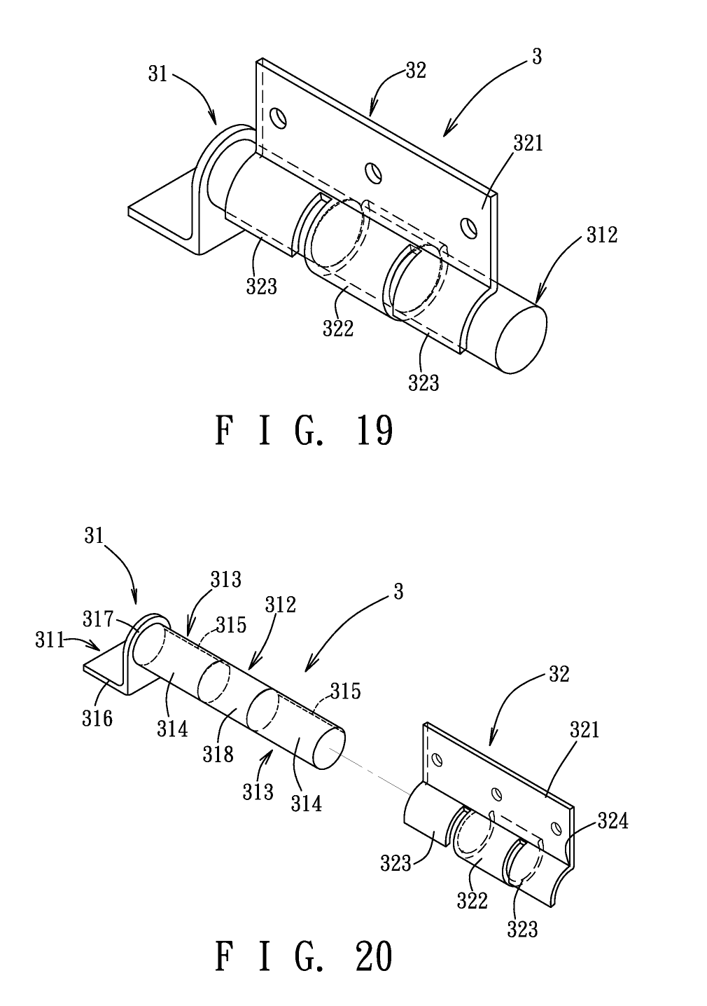

FIGS. 19 and 20 illustrate a fifth embodiment of the electronic device 100 (as shown in FIG. 1) according to the present invention. The overall structure and operation of the fifth embodiment are substantially the same as those of the first embodiment, except that structures of the first coupling member 31 and the second coupling member 32 are slightly different.

In this embodiment, the number of the second axle segment 318 of the pivot axle 312 of the first coupling member 31 is one and the pivot axle 312 includes two of the first axle segments 313 respectively connected to two opposite ends of the second axle segment 318. One of the two first axle segments 313 protrudes from the second plate body 317 of the securing plate 311. The number of the sleeve 322 of the second coupling member 32 is one, and the second coupling member 32 includes two of the elastic abutting arms 323 that respectively extend from the side end 324 of the connecting plate 321 and are separately located proximate to two opposite ends of the sleeve 322. Each of the elastic abutting arms 323 abuts against the outer peripheral surface 314 of a corresponding one of the first axle segments 313. The torques (T) (refer to FIG. 10) respectively generated by the two elastic abutting arms 323 may together form a greater force to cause the second coupling member 32 to automatically rotate relative to the pivot axle 312 after reaching the predetermined angle (A) (as shown in FIG. 7) and improve the uniformity of the force acting in the automatic rotation, so that the cover body 2 (as shown in FIG. 7) may smoothly, rapidly and automatically pivot to the closed state.

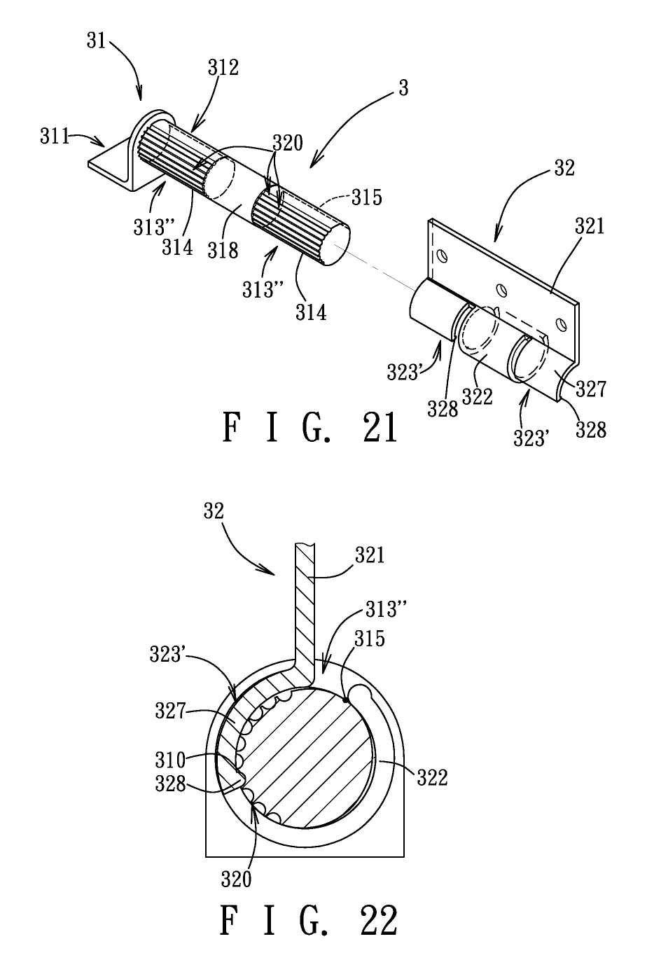

FIGS. 21 and 22 illustrate a sixth embodiment of the electronic device 100 (as shown in FIG. 1) according to the present invention. The overall structure and operation of sixth embodiment are substantially the same as those of the fifth embodiment, while the design of each of the first axle segments 313″ of the first coupling member 31 and the design of each of the elastic abutting arms 323′ of the second coupling member 32 are the same as those of the second embodiment.

When the cover body 2 (as shown in FIG. 7) is pivoted by the user to a desired angle, in addition to the frictional forces between the sleeve 322 of the second coupling member 32 and the second axle segment 318 and between each elastic abutting arm 323′ and the outer peripheral surface 314 of the corresponding first axle segment 313″, the hooks 328 of the two elastic abutting arms 323′ are respectively engaged in two corresponding positioning grooves 320, and thus the cover body 2 may be stably positioned at the desired angle.

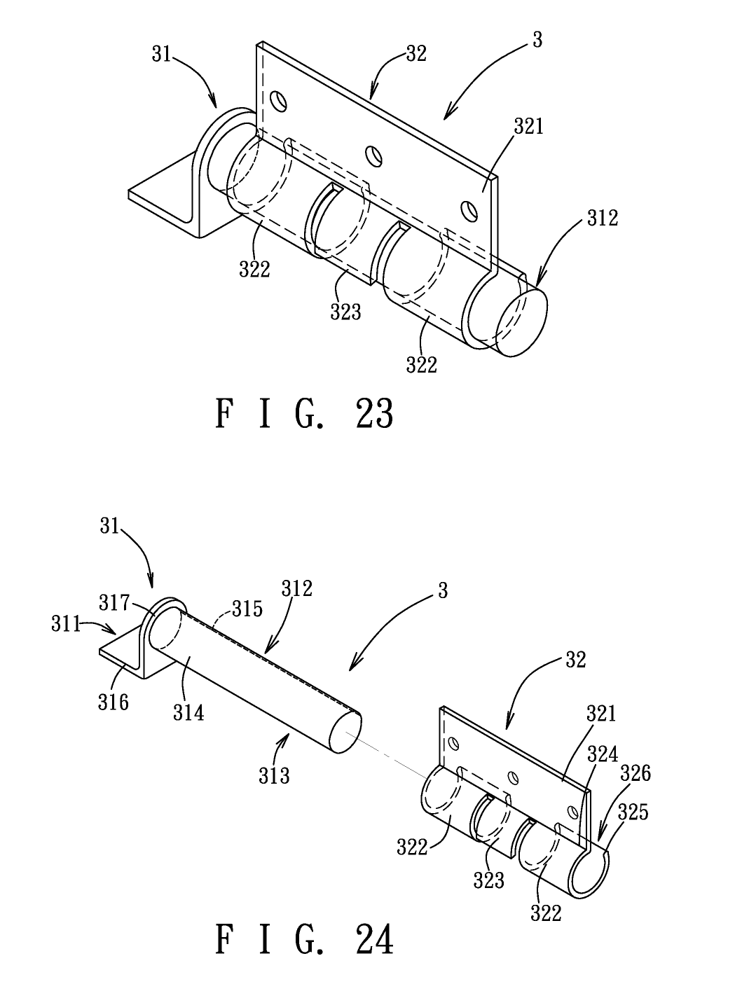

FIGS. 23 and FIG. 24 illustrate a seventh embodiment of the electronic device 100 (as shown in FIG. 1) according to the present invention. The overall structure and operation of seventh embodiment are substantially the same as those of the third embodiment, except that structure of the first coupling member 31 is slightly different.

In this embodiment, the pivot axle 312 only includes one first axle segment 313while the second axle segment 318 (refer to FIG. 16) is omitted, where the first axle segment 313 is connected to and protrudes from the second plate body 317 of the securing plate 311, and the length of the protruding portion 315 is the same as that of the first axle segment 313.

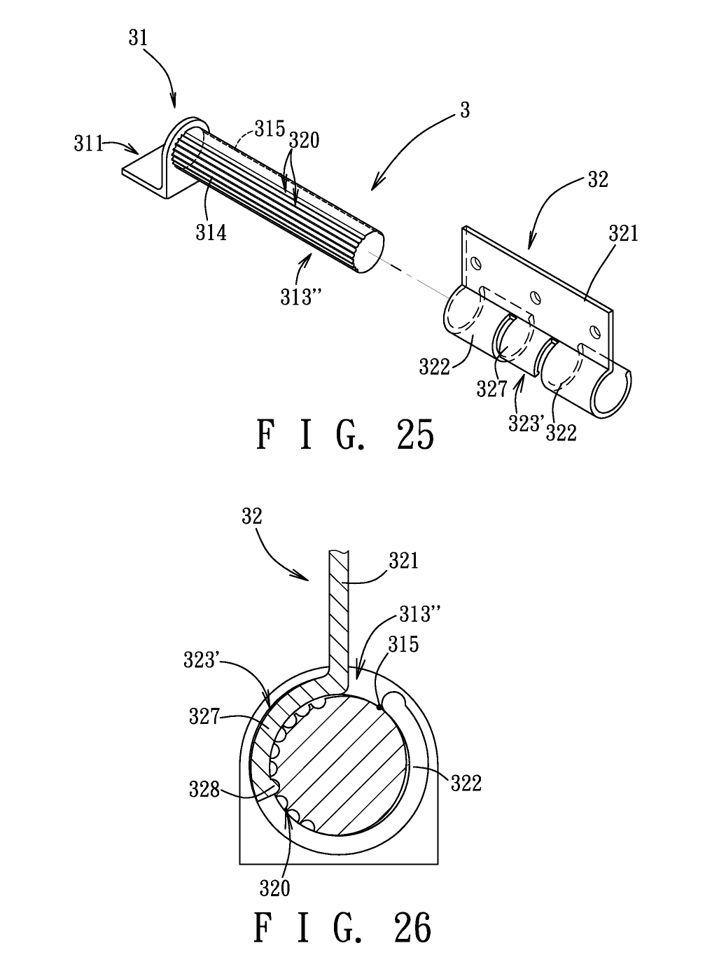

FIGS. 25 and 26 illustrate an eighth embodiment of the electronic device 100 (as shown in FIG. 1) according to the present invention. The overall structure and operation of the eighth embodiment are the same as those of the seventh embodiment, where the design of the first axle segment 313″ of the first coupling member 31 and the design of the elastic abutting arm 323′ of the second coupling member 32 are the same those of the second embodiment.

In summary, each hinge 3 of each of the embodiments is designed such that the sleeve(s) 322 of the second coupling member 32 is rotatably sleeved on the pivot axle(s) 312 of the first coupling member 31 and is capable of being positioned on the pivot axle 312, and that the elastic abutting arm (s) 323, 323′ abuts against the first axle segment(s) 313, 313′, 313″ of the pivot axle 312 and provides the torque (T) to realize the autolock of the cover body 2, so that each hinge 3 has fewer constituting components and a smaller volume in design, thereby reducing the space occupied thereby in the main body 1 and the cover body 2. Furthermore, the autolock function of the cover body 2 can be easily achieved by the cooperation of the elastic abutting arm(s) 323, 323′ and the first axle segment(s) 313, 313′, 313″. Due to the good elasticity of the elastic abutting arm 323, 323′, the elastic fatigue problem is unlikely to occur during opening and closing of the cover body 2 relative to the main body 1, even after a long term use, thereby effectively improving the service life of the hinge 3. Thus, the objects of the present invention can indeed be achieved.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A hinge, comprising:
a first coupling member including a pivot axle, said pivot axle including at least one first axle segment that has a non-circular cross section perpendicular to a central axis of said pivot axle, said first axle segment including a curvy outer peripheral surface and a protruding portion that is formed on said outer peripheral surface; and
a second coupling member including a connecting plate, at least one sleeve and at least one elastic abutting arm, said connecting plate having a side end, said sleeve being bent and extending from said side end and including a free end that is spaced from said connecting plate so as to form a gap therewith, said sleeve being rotatably sleeved on said pivot axle and capable of being positioned on said pivot axle, said elastic abutting arm extending from said side end and being spaced from said sleeve, said elastic abutting arm corresponding in position to said first axle segment and abutting against said outer peripheral surface, said protruding portion being disposed in a path of rotation of said elastic abutting arm, such that when said second coupling member is rotated to a predetermined angle relative to said first coupling member along a closing direction, said elastic abutting arm is elastically deformed to abut against said protruding portion and form a torque in the closing direction.

2. The hinge of claim 1, wherein said outer peripheral surface is formed with a plurality of positioning grooves that are spaced from one another and that respectively correspond to different angles, said elastic abutting arm including an elastic arm portion that is connected with said connecting plate and a hook that protrudes from an end of said elastic arm portion, said hook being removably engaged in one of said positioning grooves.

3. The hinge of claim 2, wherein each of said positioning grooves is arc-shaped, tooth- shaped or zigzag-shaped in cross section, the shape of said hook in cross section matching that of each of said positioning grooves.

4. The hinge of claim 1, wherein said pivot axle further includes a second axle segment connected to one end of said first axle segment, said second axle segment having a circular cross section perpendicular to said central axis of said pivot axle, said sleeve being rotatably sleeved on said second axle segment.

5. The hinge of claim 1, wherein said pivot axle further includes two second axle segments respectively connected to two opposite ends of said first axle segment, each of said second axle segments having a circular cross section perpendicular to said central axis of said pivot axle, said second coupling member including two of said sleeves that are respectively located proximate to two opposite ends of said elastic abutting arm, each of said sleeves being rotatably sleeved on a corresponding one of said second axle segments.

6. The hinge of claim 1, wherein said pivot axle includes two of said first axle segments, and further includes a second axle segment, said first axle segments being respectively connected to two opposite ends of said second axle segment, said second axle segment having a circular cross section perpendicular to said central axis of said pivot axle, said sleeve being rotatably sleeved on said second axle segment, said second coupling member including two of said elastic abutting arms that are respectively located proximate to two opposite ends of said sleeve, each of said elastic abutting arms abutting against said outer peripheral surface of a corresponding one of said first axle segments.

7. The hinge of claim 1, wherein said sleeve corresponds in position to said first axle segment, and is rotatably sleeved on said first axle segment.

8. The hinge of claim 1, wherein said first axle segment is a cam.

9. The hinge of claim 1, wherein said outer peripheral surface includes a curved section and a straight section connected with said curved section, said protruding portion being formed at a junction of said curved section and said straight section.

10. An electronic device comprising:
a main body;
a cover body; and
a hinge connected between said main body and said cover body, said cover body being pivotable relative to said main body between an open state where said cover body uncovers said main body and a closed state where said cover body covers said main body, said hinge including
a first coupling member including a securing plate that is connected to said main body and a pivot axle that protrudes from said securing plate, said pivot axle including at least one first axle segment that has a non-circular cross section perpendicular to a central axis of said pivot axle, said first axle segment including a curvy outer peripheral surface and a protruding portion that is formed on said outer peripheral surface, and
a second coupling member including a connecting plate that is connected to said cover body, at least one sleeve and at least one elastic abutting arm, said connecting plate having a side end, said sleeve being bent and extending from said side end and including a free end that is spaced from said connecting plate to form a gap therewith, said sleeve being rotatably sleeved on said pivot axle and capable of being positioned on said pivot axle, said elastic abutting arm extending from said side end and being spaced from said sleeve, said elastic abutting arm corresponding in position to said first axle segment and abutting against said outer peripheral surface, said protruding portion being disposed in a path of rotation of said elastic abutting arm, such that when said cover body brings said second coupling member to rotate to a predetermined angle at said open state relative to said first coupling member along a closing direction, said elastic abutting arm is elastically deformed to abut against said protruding portion and form a torque in said closing direction, so as to enable said cover body to automatically move into said closed state, the position of said protruding portion corresponding to said predetermined angle.

11. The electronic device of claim 10, wherein said outer peripheral surface is formed with a plurality of positioning grooves that are spaced from one another and that respectively correspond to different angles, said elastic abutting arm including an elastic arm portion that is connected with said connecting plate and a hook that protrudes from an end of said elastic arm portion, said hook being removably engaged in one of said positioning grooves.

12. The electronic device of claim 11, wherein each of said positioning grooves is arc-shaped, tooth-shaped or zigzag-shaped in cross section, the shape of said hook in cross section matching that of each of said positioning grooves.

13. The electronic device of claim 10, wherein said pivot axle further includes a second axle segment connected to one end of said first axle segment, said second axle segment having a circular cross section perpendicular to said central axis of said pivot axle, said sleeve being rotatably sleeved on said second axle segment.

14. The electronic device of claim 10, wherein said pivot axle further includes two second axle segments respectively connected to two opposite ends of said first axle segment, each of said second axle segments having a circular cross section perpendicular to said central axis of said pivot axle, said second coupling member including two of said sleeves that are respectively located proximate to two opposite ends of said elastic abutting arm, each of said sleeves being rotatably sleeved on a corresponding one of said second axle segments.

15. The electronic device of claim 10, wherein said pivot axle includes two of said first axle segments and further includes a second axle segment, said first axle segments being respectively connected to two opposite ends of said second axle segment, said second axle segment having a circular cross section perpendicular to said central axis of said pivot axle, said sleeve being rotatably sleeved on said second axle segment, said second coupling member including two of said elastic abutting arms that are respectively located proximate to two opposite ends of said sleeve, each of said elastic abutting arms abutting against said outer peripheral surface of a corresponding one of said first axle segments.

16. The electronic device of claim 10, wherein said sleeve corresponds in position to said first axle segment, and is rotatably sleeved on said first axle segment.

17. The electronic device of claim 10, wherein said first axle segment is a cam.

18. The electronic device of claim 10, wherein said outer peripheral surface includes a curved section and a straight section connected with said curved section, said protruding portion being formed at a junction of said curved section and said straight section.
